(19) United States
(12) Patent Application Publication
(10) Pub. No.: US 2023/0383602 A1
(43) Pub. Date: Nov. 30, 2023

(54) LADDER/RAMP

(71) Applicant: Canoo Technologies Inc., Torrance, CA (US)

(72) Inventors: Anthony Aquila, Justin, TX (US); Richard Kim, Los Angeles, CA (US); Arthur Henrique Martins Junior, Los Angeles, CA (US); Jackson Eric Luttig, Rancho Palos Verdes, CA (US); Iliya Bridan, Long Beach, CA (US); Chacko Abraham, Torrance, CA (US); Mark Smith, Torrance, CA (US)

(21) Appl. No.: 17/804,045

(22) Filed: May 25, 2022

(51) Int. Cl. E06C 5/02; E06C 1/387

(52) U.S. Cl. CPC E06C 5/02; E06C 1/387

(57) ABSTRACT

For use as an accessory with a multi-purpose vehicle having enclosed and rooftop cargo storage, a ladder/ramp includes a pair of siderails and crossbars extending between the siderails. A plurality of panels are each rotatably mounted between the siderails adjacent to one of a plurality of the crossbars, with each panel selectively rotatable between a closed position substantially aligned with the siderails and an open position extending outwardly from the siderails. When the panels are in the closed position, the panels and the crossbars collectively form a substantially continuous surface between the siderails on which wheels can be rolled. When the panels are in the open position, the panels each form a step that may support at least about 250 pounds. The panels may snap into place when moved into the open or closed positions, to prevent inadvertent movement therefrom.

### TECHNICAL FIELD

This disclosure relates generally to vehicle accessories. More specifically, this disclosure relates to a reconfigurable ladder/ramp for use with a multi-purpose vehicle.

### BACKGROUND

Automobiles, or vehicles, may include both internal and external cargo storage. In some designs, such as cargo vans, the cargo storage may include both enclosed storage space within the vehicle body and storage (e.g., a luggage rack) on the vehicle roof. Loading and unloading such cargo storage may require equipment such as a ladder, for reaching the upper storage rack, or a ramp or lift mechanism, for wheeling or raising/lowering heavy cargo into the enclosed cargo storage.

### SUMMARY

This disclosure relates to an accessory for use with a multi-purpose vehicle having enclosed and rooftop cargo storage.

In certain embodiments, a ladder/ramp includes a pair of siderails and crossbars extending between the siderails. A plurality of panels are each rotatably mounted between the siderails adjacent to one of a plurality of the crossbars, with each panel selectively rotatable between a closed position substantially aligned with the siderails and an open position extending outwardly from the siderails.

In certain embodiments, a method of forming a ladder/ramp includes providing a pair of siderails with crossbars extending between the siderails, and a plurality of panels each rotatably mounted between the siderails adjacent to one of a plurality of the crossbars. Each panel is selectively rotatable between a closed position substantially aligned with the siderails and an open position extending outwardly from the siderails.

In certain embodiments, a method of adapting a vehicle for use with the ladder/ramp includes providing a vehicle comprising a chassis, wheels mounted to the chassis, a motor mounted to the chassis, and a vehicle body mounted to the chassis. The method also includes providing a ladder/ramp comprising a pair of siderails with crossbars extending between the siderails, and a plurality of panels each rotatably mounted between the siderails adjacent to one of a plurality of the crossbars, wherein each panel is selectively rotatable between a closed position substantially aligned with the siderails and an open position extending outwardly from the siderails. The method further includes mounting a storage rack on top of the vehicle body, the storage rack including a portion configured to hold the ladder/ramp.

In some embodiments, when the panels are in the closed position, the panels and the crossbars collectively form a substantially continuous surface between the siderails on which wheels can be rolled.

In some embodiments, the surface formed by the panels and crossbars includes a non-slip surface.

In some embodiments, the panels snap into place when moved into the closed position to prevent inadvertent movement toward the open position.

In some embodiments, the panels snap into place when moved into the open position to prevent inadvertent movement toward the open position.

In some embodiments, each panel is configured to support at least 250 pounds when the respective panel is in the open position.

In some embodiments, each of the plurality of panels is configured to rotate independently of remaining ones of the plurality of panels.

In some embodiments, first ends of each of the siderails form a support for engaging a portion of the vehicle when the ladder/ramp is used as a ladder and when the ladder/ramp is used as a ramp.

In some embodiments, each of the panels includes a non-slip surface on an upper surface of the respective panel, when the respective panel is in the open position.

In some embodiments, a vehicle configured for use with a ladder/ramp includes a chassis, wheels mounted to the chassis, a motor mounted to the chassis, a vehicle body mounted to the chassis, and a storage rack on top of the vehicle body, with the storage rack including a portion configured to hold the ladder/ramp.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 is a perspective view of a vehicle with which the ladder/ramp is being used in the ladder configuration according to embodiments of the present disclosure;

FIG. 2 is view of the ladder/ramp from FIG. 1 in isolation;

FIG. 3 a perspective view of a vehicle with which the ladder/ramp is being used in the ramp configuration according to embodiments of the present disclosure; and

FIG. 4 is view of the ladder/ramp from FIG. 3 in isolation.

### DETAILED DESCRIPTION

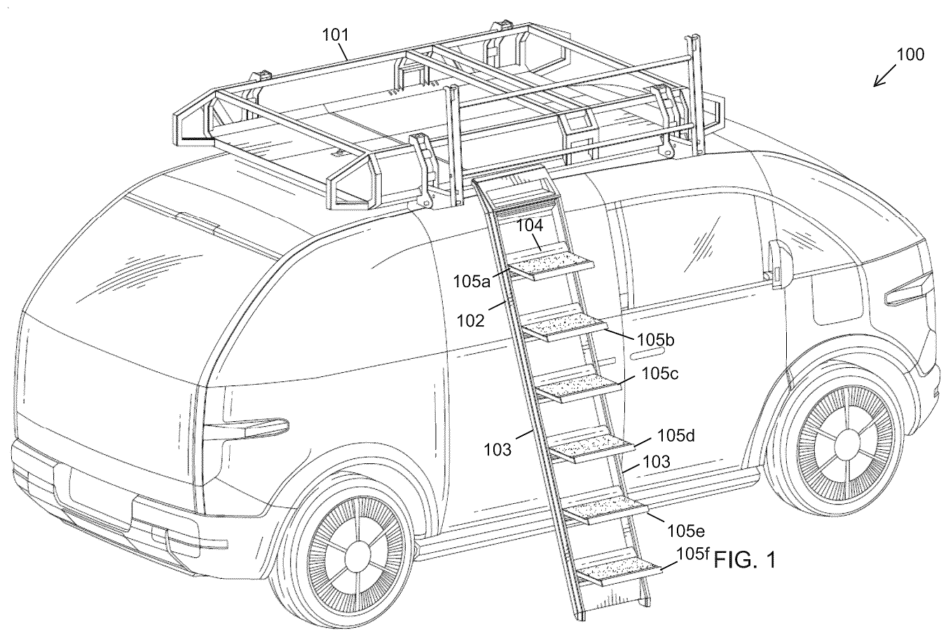

FIGS. 1 through 4, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

FIG. 1 is a perspective view of a vehicle with which the ladder/ramp is being used in the ladder configuration according to embodiments of the present disclosure. The embodiment of the vehicle 100 illustrated in FIG. 1 is for illustration and explanation only. FIG. 1 does not limit the scope of this disclosure to any particular implementation of a vehicle.

In the example illustrated in FIG. 1, the vehicle 100 includes a body having enclosed storage (not visible in FIG. 1) and a roof-mounted storage rack 101. The vehicle body includes a cabin for carrying at least the vehicle operator, doors for access to the interior of the body, and at least front windows and rearview mirrors for the operator to see out of the cabin and areas to the sides of the vehicle 100. The vehicle body is mounted on a chassis (not shown) to which a motor, powertrain, and wheels are also mounted. The storage rack 101 may be configured to hold containers and, preferably, provides mounts to which the ladder/ramp may be secured.

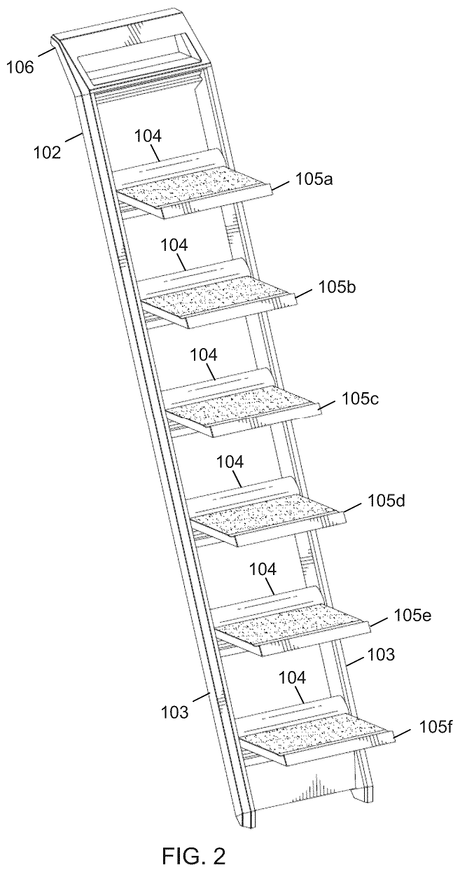

A ladder/ramp 102 is provided for use with the vehicle 100. The ladder/ramp 102 includes a pair of parallel, space apart siderails 103 with a plurality of crossbars 104 extending therebetween. Pivotably mounted to each crossbar 104 is a shutter-step 105a, 105b, 105c, 105d, 105e or 105f. The ladder/ramp 102 is illustrated in FIGS. 1 and 2 with the shutter-steps 105a-105f in the “open” or deployed position. In that position, the panels for the shutter-steps 105a-105f are rotated away from alignment with the siderails 103 and extend outward to form step surfaces. The step surfaces are preferably about 10 to 18 inches in width and 9 to 12 inches deep. The crossbars 104 and/or stop(s) associated with each shutter-step limit rotation of the shutter-steps 105a-105f, each of which preferably supports at least approximately 250 pounds (lbs) in the open position. While gravity should keep each panel of the shutter-steps 105a-105f in the open position when ladder/ramp 102 is deployed for use as a ladder, each panel may optionally “snap” into place when moved into the open position, to prevent inadvertent movement toward the closed position.

The bottom ends of the siderails 103 form feet for the ladder/ramp 102, and the top ends are fitted with a structure 106 for resting on a support on the roof of vehicle 100 proximate to the storage rack 101, or on a side of the vehicle 100, When in use as a ladder, the structure 106 rests on the support on the vehicle 100, and the feet ends of siderails 103 rest on the ground adjacent to the vehicle. The user can climb the ladder to stow or retrieve cargo in the storage rack 101.

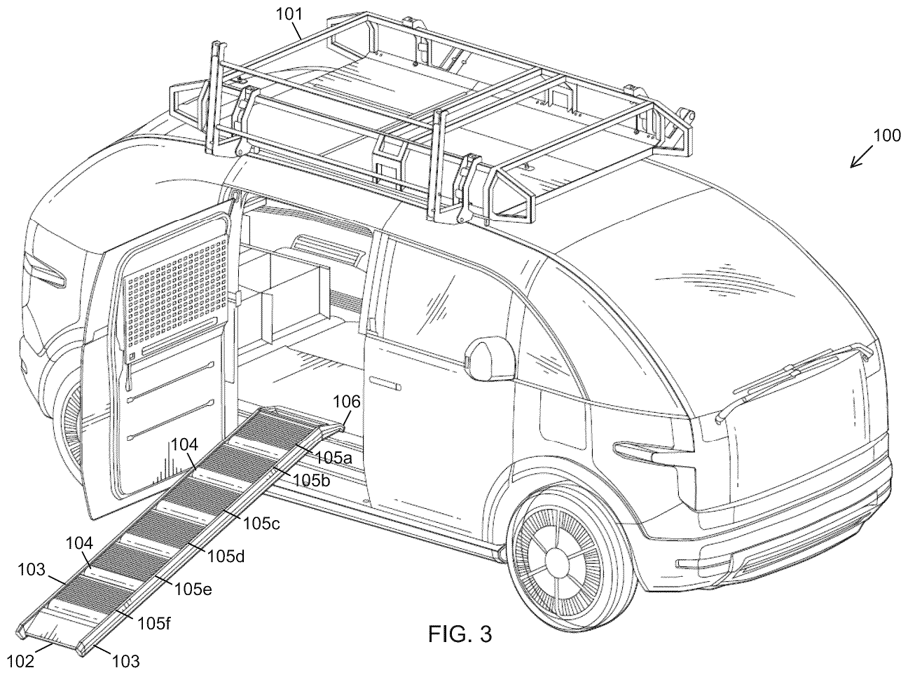

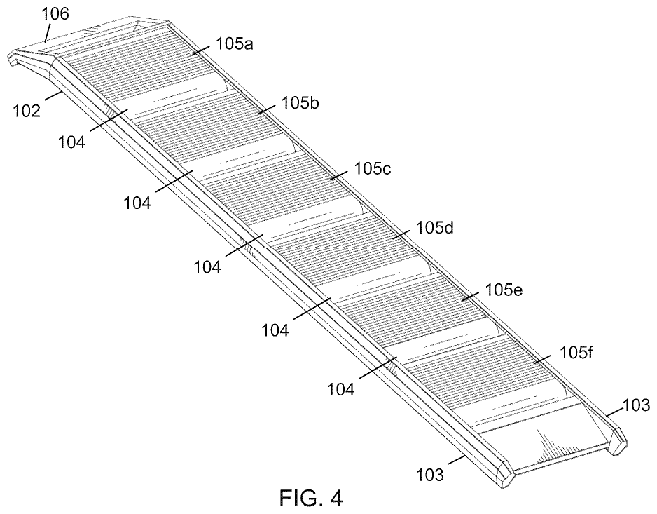

FIG. 3 a perspective view of a vehicle with which the ladder/ramp is being used in the ramp configuration according to embodiments of the present disclosure. FIG. 4 is view of the ladder/ramp from FIG. 3 in isolation. The ladder/ramp 102 is illustrated in FIGS. 3 and 4 with the shutter-steps 105a-105f in the “closed” or retracted position. In that position, the panels for the shutter-steps 105a-105f are rotated into substantial alignment with the siderails 103 and form, together with the crossbars 104, a substantially smooth surface. The panels preferably “snap” fit into the aligned position with the siderails, to preclude inadvertent rotation toward the “open” position during movement of the ladder/ramp 102. The panels for each of shutter-steps 105a-105f preferably rotate independently of each other, so that as many or as few as necessary can be rotated to the “open” position for use of the ladder/ramp 102 as a ladder.

When in use as a ramp, the structure 106 rests on the support inside the enclosed cargo storage of the vehicle 100, or on an edge of that enclosure. The ramp thus allows a dolly or wheeled containers to be rolled up into the enclosed storage, or rolled down out of the enclosed storage. While in the configuration illustrated in FIG. 4, the ladder/ramp 102 may be stowed for transportation, for example on a portion of storage rack 101 as described above.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A ladder/ramp, comprising:
a pair of siderails;
crossbars extending between the siderails;
a plurality of panels each rotatably mounted between the siderails adjacent to one of a plurality of the crossbars, each panel selectively rotatable between a closed position substantially aligned with the siderails and an open position extending outwardly from the siderails.

2. The ladder/ramp according to claim 1, wherein, when the panels are in the closed position, the panels and the crossbars collectively form a substantially continuous surface between the siderails on which wheels can be rolled.

3. The ladder/ramp according to claim 2, wherein the surface formed by the panels and crossbars includes a non-slip surface.

4. The ladder/ramp according to claim 1, wherein the panels snap into place when moved into the closed position to prevent inadvertent movement toward the open position.

5. The ladder/ramp according to claim 1, wherein the panels snap into place when moved into the open position to prevent inadvertent movement toward the open position.

6. The ladder/ramp according to claim 1, wherein each panel is configured to support at least 250 pounds when the respective panel is in the open position.

7. The ladder/ramp according to claim 1, wherein each of the plurality of panels is configured to rotate independently of remaining ones of the plurality of panels.

8. The ladder/ramp according to claim 1, wherein first ends of each of the siderails form a support for engaging a portion of the vehicle when the ladder/ramp is used as a ladder and when the ladder/ramp is used as a ramp.

9. The ladder/ramp according to claim 1, wherein each of the panels includes a non-slip surface on an upper surface of the respective panel, when the respective panel is in the open position.

10. A vehicle configured for use with the ladder/ramp according to claim 1, the vehicle further comprising:
a chassis;
wheels mounted to the chassis;
a motor mounted to the chassis;
a vehicle body mounted to the chassis; and
a storage rack on top of the vehicle body, the storage rack including a portion configured to hold the ladder/ramp.

11. A method of forming a ladder/ramp, the method comprising:
providing a pair of siderails with
crossbars extending between the siderails, and
a plurality of panels each rotatably mounted between the siderails adjacent to one of a plurality of the crossbars,
wherein each panel is selectively rotatable between a closed position substantially aligned with the siderails and an open position extending outwardly from the siderails.

12. The method according to claim 11, wherein, when the panels are in the closed position, the panels and the crossbars collectively form a substantially continuous surface between the siderails on which wheels can be rolled.

13. The method according to claim 12, wherein the surface formed by the panels and crossbars includes a non-slip surface.

14. The method according to claim 11, wherein the panels snap into place when moved into the closed position to prevent inadvertent movement toward the open position.

15. The method according to claim 11, wherein the panels snap into place when moved into the open position to prevent inadvertent movement toward the open position.

16. The method according to claim 11, wherein each panel is configured to support at least 250 pounds when the respective panel is in the open position.

17. The method according to claim 11, wherein each of the plurality of panels is configured to rotate independently of remaining ones of the plurality of panels.

18. The method according to claim 11, wherein first ends of each of the siderails form a support for engaging a portion of the vehicle when the ladder/ramp is used as a ladder and when the ladder/ramp is used as a ramp.

19. The method according to claim 11, wherein each of the panels includes a non-slip surface on an upper surface of the respective panel when the respective panel is in the open position.

20. A method of adapting a vehicle for use with the ladder/ramp, the method comprising:
providing a vehicle comprising a chassis, wheels mounted to the chassis, a motor mounted to the chassis, and a vehicle body mounted to the chassis;
providing a ladder/ramp comprising a pair of siderails with crossbars extending between the siderails, and a plurality of panels each rotatably mounted between the siderails adjacent to one of a plurality of the crossbars, wherein each panel is selectively rotatable between a closed position substantially aligned with the siderails and an open position extending outwardly from the siderails; and
mounting a storage rack on top of the vehicle body, the storage rack including a portion configured to hold the ladder/ramp.
